(19) United States
(12) Patent Application Publication
(10) Pub. No.: US 2003/0127978 A1
(43) Pub. Date: Jul. 10, 2003

(54) Multi-position hid lamp with single getter

(76) Inventors: David Hrubowchak, Litchfield, NH (US); Paul W. Oberlies, Manchester, NH (US)

Correspondence Address: William H. McNeill, OSRAM SYLVANIA Inc., 100 Endicott Street, Danvers, MA, 01923, US

(21) Appl. No.: 10/041,172

(22) Filed: Jan. 8, 2002

(51) Int. Cl. H01J 17/24

(52) U.S. Cl. 313/560

(57) ABSTRACT

An arc discharge lamp for operation in either a vertical base up or horiozontal position has a single getter located on the longitudinal axis of the lamp at a position between a heat shield located in the neck of the lamp and the base of the lamp.

### TECHNICAL FIELD

This invention relates to metal halide arc discharge lamps and more particularly to such lamps needing only a single getter to be operational in vertical base up or horizontal positions.

### BACKGROUND ART

Metal halide arc discharge lamps are frequently employed in commercial usage because of their high luminous efficacy and long life. A typical metal halide arc discharge lamp includes a quartz or fused silica arc tube that is hermetically sealed within a borosilicate glass outer envelope. The arc tube, itself hermetically sealed, has tungsten electrodes sealed into opposite ends and contains a fill material, which may include memory, metal halide additives and a rare gas to facilitate starting. In some cases, particularly in high wattage lamps, the outer envelope is filled with nitrogen or another inert gas at less than atmospheric pressure. In other cases, particularly in low wattage lamps, the outer envelope is evacuated.

In either case the outer lamp envelope is usually provided with a getter, a device capable of absorbing extraneous gases that may be evolved during operation of the lamp and thus maintain the desired quality wthin the outer envelope and intenal arc tube. Since the getter is thermally operated within a relatively narrow range of temperatures, and it depends for operation upon the heat generated by the arc tube, its placement in the lamp is critical and is usually dependent upon the placement of the lamp. That is, these position-restricted lamps are usually designed for operation in a single orientation, either vertically with the base up or horizontal. For vertical base up operation getter placement is relatively easily achieved by locating the getter between the base and the arc tube. However, for horizontal operation, getter placement is more difficult because it is not always possible to know in advance what the rotational position of the lamp will be when it is installed. To accommodate this condition, lamps designed for horizontal operation were supplied with two getters, an additional expense.

### DISCLOSURE OF INVENTION

It is, therefore, an object of the invention to obviate the disadvantages of the prior art.

It is another object of the invention to enhance the operation of metal halide arc discharge lamps.

These objects are accomplished, in one aspect of the invention by a multi-positionable arc lamp that comprises an envelope having a longitudinal axis with a bulbous portion and a cylindrical neck portion symmetrically arrayed thereabout. The neck portion terminates in a base. An arc tube is mounted by a mounting frame within the bulbous portion and coaxially arrayed with the longitudinal axis. A heat shield is mounted witin the neck portion transversely of the longitudinal axis and a getter is mounted adjacent the heat shield between the heat shield and the base. The getter is symmetrically arrayed on the longitudinal axis.

Lamps so constructed are not dependent upon their mounted orientation for proper operation of the getter and are equally suitable for vertical base up operation or horizontal operation independent of final rotational position.

### BRIEF DESCRIPTION OF THE DRAWINGS

FIG. 1 is a diagrammatic elevational view of an embodiment of the invention in a first rotational position; and

FIG. 2 is a similar view with the lamp in a different rotational position.

### BEST MODE FOR CARRYING OUT THE INVENTION

For a better understanding of the present invention, together with other and further objects, advantages and capabilities thereof reference is made to the following disclosure and appended claims in conjunction with the above-described drawings.

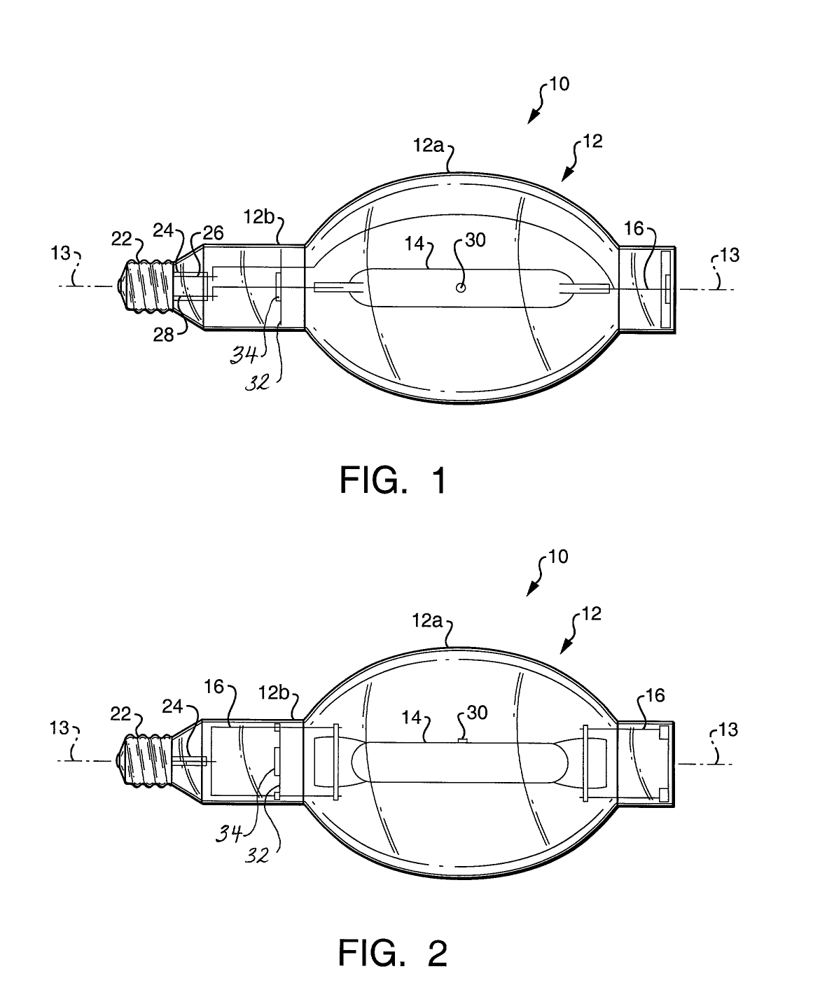

Referring now to the drawings with greater particularity, there is shown in FIG. 1 an exemplary metal halide arc discharge lamp 10 having a longitudinal axis 13 and including a lamp envelope 12 with a bulbous portion 12a and a cylindrical neck portion 12b arrayed therealong. An arc tube 14 is mounted within the envelope by a mounting frame 16 and is coaxial with the axis 13. Electrical energy is coupled to the arc tube 14 through a base 22, a lamp stem 24 and electrical leads 26 and 28, shown most clearly in FIG. 1. The arc tube contains a chemical fill or dose of materials to provide light when an arc is initiated therein, as is known. Generally, the fill is administered to the arc tube via a tubulation 30.

A heat shield 32 is positioned in the neck 12b, between the arc tube and the base and is comprised of a suitable material such as stainless steel. The shield 32 is circular to conform to the cylindrical neck 12b and is positioned transversely of the longitudinal axis 13.

A getter 34, which preferably is circular and contains a suitable gettering agent such as barium peroxide, is positioned adjacent the heat shield between the shield and the base and is symmetrically located on the axis 13. With the getter so positioned it functions properly whether the lamp is installed vertically base up or horizontally. Further, the rotational alignment of the lamp in the horizontal installation is immaterial in so far as the getter is concerned, as is clearly shown in FIG. 2, where the lamp is rotated 90 degrees from the lamp of FIG. 1. For clarity, the electrical connections of the lamp are not shown in FIG. 2.

The getter 34 is preferably held in position by a nickel ribbon welded to both components.

In tests with lamps designed for operation at 750 watts the getter achieved its working-range temperature of between 300 and 340° C. within 10 minutes in the vertical base up position and within 20 minutes in the horizontal position.

While there have been shown and described what are at present considered to be the preferred embodiments of the invention, it will be apparent to those skilled in the art that various changes and modification can be made herein without departing from the scope of the invention as defined by the appended claims.

What is claimed is:

1. A multi-positionable arc lamp comprising: an envelope having a longitudinal axis with a bulbous portion and a cylindrical neck portion symmetrically arrayed thereabout, said neck portion terminating in a base; an arc tube mounted by a mounting frame within said bulbous portion and coaxially arrayed with said longitudinal axis; a heat shield mounted within said neck portion transversely of said longitudinal axis; and a getter mounted adjacent said heat shield between said heat shield and said base, said getter being symmetrically arrayed on said longitudinal axis.

2. The arc lamp of claim 1 wherein said getter is affixed to said heat shield.

3. The arc lamp of claim 2 wherein said getter contains BₐO₂.

4. The arc lamp of claim 2 wherein said heat shield is constructed of stainless steel.
